(19) United States
(12) Patent Application Publication
(10) Pub. No.: US 2012/0230160 A1
(43) Pub. Date: Sep. 13, 2012

(54) HAND-WOUND TIMEPIECE RETURN SPRING STRUCTURE, AND HAND-WOUND MECHANISM AND HAND-WOUND TIMEPIECE HAVING THE SAME

(76) Inventors: Takeshi TOKORO, Chiba-shi (JP); Toshiyuki Fujiwara, Chiba-shi (JP)

(21) Appl. No.: 13/409,242

(22) Filed: Mar. 1, 2012

(30) Foreign Application Priority Data
Mar. 8, 2011 (JP) 2011-050672

(51) Int. Cl. G04B 3/00

(52) U.S. Cl. 368/206

(57) ABSTRACT

A return spring structure of a hand-wound timepiece has a plate-like placement portion that is placed on a surface of a support member. A forced insertion hooking spring portion is forcibly inserted into an opening of a locking plate-like portion of the support member, and has a forced insertion hooking end portion locked in a back surface of a wall defining the opening and a hooking spring arm portion extending from one edge portion of the plate-like placement portion. A return spring portion extends from the other edge portion of the plate-like placement portion. The return spring structure also has a positioning spring portion that includes a positioning spring arm portion extending parallel to the hooking spring arm portion from the one edge portion of the plate-like placement portion and a forced insertion engagement end portion engaged with the opening of the support member at the forward end portion.

### BACKGROUND OF THE INVENTION

1. Field of the Invention

The present invention relates to a hand-wound timepiece return spring structure, and a hand-wound mechanism and a hand-wound timepiece having the same.

2. Description of the Related Art

In a timepiece having both of an automatically wound mechanism and a manually wound mechanism (hand-wound mechanism) of a mainspring, a train wheel (ratchet sliding wheel or intermediate second transmitting wheel) which configures a hand-wound mechanism is connected to an intermediate wheel (for example, second transmitting wheel) among wheels, which configure an automatic train wheel, ranging from an oscillating weight to a ratchet wheel. When the mainspring is wound by the automatically wound mechanism, the loss of energy is caused by rotating wheels between a winding pinion and the ratchet sliding wheel (intermediate second transmitting wheel) among the hand-wound train wheel. In order to avoid the loss, the rotation center axis of the ratchet sliding wheel rocks to retreat during the winding using the automatically wound mechanism such that the meshing between the ratchet sliding wheel and the second transmitting wheel is released (for example, JP-A-2006-258795 (Patent Reference 1)).

When the mainspring is manually wound (hand-wound) around a center axis of a winding stem by rotating a crown, the ratchet sliding wheel which retreats to a non-meshing position from the second transmitting wheel is rotated by a crown wheel and meshes with the second transmitting wheel by receiving an oscillating torque in a direction of being set in a meshing position in which the ratchet sliding wheel meshes with the second transmitting wheel. It is known that a return spring is provided so as to reliably perform the displacement of the ratchet sliding wheel from the non-meshing position to the meshing position (JP-A-2003-279667 (Patent Reference 2)).

The return spring disclosed in Patent Reference 2 (holding member 83 of FIG. 6 disclosed in Patent Reference 1) is screw-fixed by an attachment portion (83A). However, since the return spring is small in practice (typically, the length equal to or less than about several mm) and also requires the screw fix under the spring load, there is a concern that the screw fix may be not easy. In addition, there is a concern that placement stability may be poor and positioning may be not easy.

In addition, as a hand-wound timepiece which includes a hand-wound mechanism having a hand-wound timepiece return spring structure which can be preliminarily fixed (locked) in principle simply by providing in a predetermined state in a predetermined position, hand-wound timepieces shown in FIG. 12 to FIG. 15 are proposed.

In a hand-wound mechanism 103 of a hand-wound timepiece 105 shown in FIG. 12, a winding pinion 114 meshing with a clutch wheel 112 and a ratchet mechanism is rotated therethrough in a XA1 direction in response to the rotation of a winding stem 110, which is in a normal needle-handling position, in the XA1 direction. In response to the rotation of the winding pinion 114 in the XA1 direction, a crown wheel 116 is rotated in a XB1 direction, a ratchet sliding wheel 120 rocks correspondingly in a XB1 direction and is rotated in a XE1 direction. Then, a ratchet wheel 130 is rotated in a XG1 direction through a second transmitting wheel 122 to wind a mainspring 142 in a movement barrel 140. In FIG. 12 and (a) to (c) of FIG. 13, reference numeral 150 represents a first wheel bridge, reference numeral 152 represents an automatic train wheel bridge, reference numeral 132 represents a ratchet wheel screw, and reference numeral 144 represents a click.

In addition, in the automatically wound mechanism (not shown), the reciprocation of the oscillating weight is transmitted to the second transmitting wheel 122 as an one-way intermittent rotation, the second transmitting wheel 122 is intermittently rotated in a XJ1 direction, the ratchet wheel 130 is intermittently rotated in the XG1 direction to wind the mainspring 142 in the movement barrel 140. When the ratchet sliding wheel 120 meshes with the second transmitting wheel 122 immediately after the hand-winding, the second transmitting wheel 122 rotates the ratchet sliding wheel 120 in the XE1 direction during the rotation of the second transmitting wheel 122 in the XJ1 direction and the ratchet sliding wheel 120 which is maintained in a state of meshing with the crown wheel 116 rocks in a XD2 direction. Accordingly, the meshing between the second transmitting wheel 122 and the ratchet sliding wheel 120 is released.

Meanwhile, in the conventional hand-wound mechanism 103 of the hand-wound timepiece 105, when the winding stem 110 is rotated in the XA1 direction through the crown (not shown), the return spring or ratchet sliding wheel spring 160 applying an elastic force YF1, which biases the ratchet sliding wheel 120 toward the rocking position in the XD1 direction, to the ratchet sliding wheel 120 is provided so as to reliably displace the ratchet sliding wheel 120, which preliminarily rocks and retreats in the XD2 direction during the operation of the automatically wound mechanism, toward a rocking position of meshing again with the second transmitting wheel 122.

Here, as seen from FIGS. 14 and 15 in addition to FIG. 12, the return spring 160 includes a rear anchor side attachment portion 161 bent in a U-shape and a pressing spring portion 163 obtained by extending a forward end side leg portion 162 having a U-shape. The pressing spring portion 163 is elastically deformable or rockable in XH1 and XH2 directions with respect to the forward end side leg portion 162 having the U-shape. In a rear anchor portion of a rear anchor side leg portion 164 having the U-shape or a forward end portion 165 on the rear anchor side, a curved locking portion 166 helping the positioning of the return spring 160 is formed. As seen from FIG. 14 in addition to FIG. 12, the return spring 160, for example, is arranged in a return spring arrangement concave portion 153 of the first wheel bridge 150 and the tip of the curved locking portion 166 is arranged in a small concave portion 153a of the concave portion 153. Accordingly, the return spring 160 is positioned.

However, the return spring 160 is not easily mounted in practice. That is, during the mounting of the return spring 160, on one hand, it is necessary that the pressing spring portion 163 is bent (retreats) in advance in the XH2 direction so as to apply the elastic force YF1 to the ratchet sliding wheel 120 in the XH1 direction. On the other hand, it is necessary that the rear anchor side attachment portion 161 is arranged in the return spring arrangement concave portion 153 of the first wheel bridge 150 such that the curved locking portion 166 is locked in the small concave portion 153a of the return spring arrangement concave portion 153. Therefore, in practice, the following is necessary: the rear anchor side attachment portion 161 is arranged in the return spring arrangement concave portion 153 of the first wheel bridge 150 such that the curved locking portion 166 is locked in the small concave portion 153a of the return spring arrangement concave portion 153; and in a state where the rear anchor side attachment portion 161 of the return spring 160 is pressed by a finger or the like so as not to be removed from the concave portion, the pressing spring portion 163 is bent in the XH2 direction to be in contact with the outer periphery of the ratchet sliding wheel 120 such that the pressing spring portion 163 can apply the elastic force YF1 to the ratchet sliding wheel 120 in the XH1 direction. That is, during the mounting of the return spring 160, it is necessary that one hand holds the rear anchor attachment portion 161 of the return spring 160 and the other hand bends or holds the pressing spring portion 163. In addition, in the return spring 160, when a force is applied to the pressing spring portion 163 by an impact or the like in a direction where the return spring 160 is removed from the return spring arrangement concave portion 153 of the first wheel bridge 150, the curved locking portion 166 is also easily removed from the small concave portion 153a even by the small impact. Furthermore, when the curved locking portion 166 is removed from the small concave portion 153a, there is a concern that the return spring 160 may be removed from the return spring arrangement concave portion 153.

### SUMMARY OF THE INVENTION

It is an aspect of the present application to provide a hand-wound timepiece return spring structure which is easily mounted and which is hardly removed after the mounting by an unexpected external force in the form of, for example, a small impact, and a hand-wound mechanism and a hand-wound timepiece having the same.

According to the present application, there is provided a hand-wound timepiece return spring structure including: a plate-like placement portion that is placed on a surface of a support member; a forced insertion hooking spring portion that is forcibly inserted into an opening of a locking plate-like portion of the support member, has a forced insertion locking end portion, which is locked in a back surface of a wall defining the opening, in the locking plate-like portion, and is provided with a hooking spring arm portion extending from one edge portion of the plate-like placement portion; and a return spring portion that extends from the other edge portion of the plate-like placement portion.

In the hand-wound timepiece return spring structure according to the present application, “a plate-like placement portion that is placed on a surface of a support member; and a forced insertion hooking spring portion that is forcibly inserted into an opening of a locking plate-like portion of the support member, has a forced insertion locking end portion, which is locked in a back surface of a wall defining the opening, in the locking plate-like portion, and is provided with a hooking spring arm portion extending from one edge portion of the plate-like placement portion” are provided. Accordingly, by pressing the forced insertion hooking spring portion in a state where the plate-like placement portion is placed on the surface of the support member and inserting the forced insertion locking end portion into the opening of the locking plate-like portion of the support member, the forced insertion locking end portion which is located at the forward end of the hooking spring arm portion extending from the one edge portion of the plate-like placement portion can be locked in the back surface of the wall defining the opening of the locking plate-like portion. As a result, the mounting can be easily performed.

Here, typically, convex and concave portions are formed on the surface of the support member where the plate-like placement portion is placed. In the plate-like placement portion, convex and concave portions which can be fitted into the above-mentioned convex and concave portions are formed substantially in the complementary shape so as to position the plate-like placement portion. The concave portion of the plate-like placement portion may be an opening (hole).

The hand-wound timepiece return spring structure according to the present application, typically, further includes a positioning spring portion that includes a positioning spring arm portion extending parallel to the hooking spring arm portion from the one edge portion of the plate-like placement portion and a forced insertion engagement end portion engaged with the opening of the support member at the forward end portion.

In this case, when the forced insertion locking end portion of the forced insertion hooking spring portion is inserted into the opening of the support member, the forced insertion engagement end portion of the positioning spring portion is also inserted to the opening and the positioning spring portion is defined at a reference position. Therefore, the hand-wound timepiece return spring structure can be reliably maintained at a predetermined position by the positioning spring arm portion and the hooking spring arm portion regardless of the state of the return spring portion. Accordingly, once the hand-wound timepiece return spring structure is mounted, the concern of being removed is further lowered.

In the hand-wound timepiece return spring structure according to the present application, typically, the forced insertion locking end portion of the forced insertion hooking spring portion has a forced insertion guiding inclination surface as a forward end side and a forced insertion locking surface as a rear anchor side.

In this case, when the forced insertion hooking spring portion is pressed and the forced insertion locking end portion is inserted into the opening of the support member, the forced insertion locking end portion is inserted into the opening through the forced insertion guiding inclination surface. Therefore, the forded insertion locking end can be easily inserted into the opening and the forced insertion locking end portion can be reliably locked through a forced insertion locking surface.

In the hand-wound timepiece return spring structure according to the present application:

(1) the other edge portion, which is connected to the return spring portion, of the plate-like placement portion may be located on a side opposite to the one edge portion, which is connected to the forced insertion hooking spring portion, of the plate-like placement portion, and the return spring portion may extend in a direction intersecting with the hooking spring arm portion of the forced insertion hooking spring portion; and

(2) the other edge portion, which is connected to the return spring portion, of the plate-like placement portion may be located adjacent to the one edge portion, which is connected to the forced insertion hooking spring portion, of the plate-like placement portion, and the return spring portion may extend parallel to the hooking spring arm portion of the forced insertion hooking spring portion.

In the latter case (that is, (2)), even when the forward end of the return spring portion in the hand-wound timepiece return spring structure receives an external force of being lifted to the rear anchor, the forced insertion hooking spring portion can regulate the return spring structure from being removed from the opening. Therefore, the concern that the return spring structure may be removed by an unexpected external force can be suppressed to the minimum.

In the hand-wound timepiece return spring structure according to the present application, typically, the plate-like placement portion has an opening which is engaged with a convex portion protruding from the surface of the support member.

In this case, the return spring structure can be stably and more reliably positioned and fixed.

According to the application, there is provided a hand-wound mechanism, in which the above-described hand-wound timepiece return spring structure applies an elastic force, which displaces a ratchet sliding wheel from a non-meshing position of releasing the meshing with a second transmitting wheel to a meshing position of meshing with the second transmitting wheel, to the ratchet sliding spring.

In addition, according to the present application, there is provided a hand-wound timepiece including the above-described hand-wound return spring structure or the above-described hand-wound mechanism.

### BRIEF DESCRIPTION OF THE DRAWINGS

FIG. 1 is a plane diagram showing a part of a hand-wound timepiece according to a preferred embodiment of the present invention which is provided with a hand-wound mechanism according to a preferred embodiment of the present invention having a ratchet sliding wheel spring as a hand-wound timepiece return spring structure according to a preferred embodiment of the present invention.

FIG. 2A to FIG. 2D are cross-sectional views showing a part of the hand-wound timepiece shown in FIG. 1. FIG. 2A is a cross-sectional view showing a ratchet sliding wheel spring structure, a ratchet sliding wheel structure, and a second transmitting wheel structure in the hand-wound mechanism of the hand-wound timepiece shown in FIG. 1. FIG. 2B is a cross-sectional view showing a arrangement state of the ratchet sliding wheel spring structure in the hand-wound mechanism of the hand-wound timepiece shown in FIG. 1. FIG. 2C is a cross-sectional view showing a state where the ratchet sliding wheel spring structure shown in FIG. 1 is locked in an opening of a first wheel bridge. FIG. 2D is a cross-sectional view showing a part of the hand-wound timepiece.

FIG. 3 is a perspective view showing the hand-wound mechanism of the hand-wound timepiece shown in FIGS. 1 and 2A to 2D.

FIG. 4 is a cutaway perspective view when viewing a part of the hand-wound mechanism of the hand-wound timepiece shown in FIGS. 1 and 2A to 2D from a direction different from that of FIG. 3.

FIG. 5 is an enlarged perspective view showing the ratchet sliding wheel spring structure shown in FIG. 1.

FIG. 6 is a plane diagram similar to FIG. 1 showing a part of a hand-wound timepiece according to another preferred embodiment of the present invention which is provided with a hand-wound mechanism according to another preferred embodiment of the present invention having a ratchet sliding wheel spring as a hand-wound timepiece return spring structure according to another preferred embodiment of the present invention.

FIG. 7 is an enlarged perspective view similar to FIG. 5 showing the ratchet sliding wheel spring shown in FIG. 6.

FIG. 8 is a plane diagram similar to FIG. 1 showing a part of a hand-wound timepiece according to still another preferred embodiment of the present invention which is provided with a hand-wound mechanism according to still another preferred embodiment of the present invention having a ratchet sliding wheel spring structure as a hand-wound timepiece return spring structure according to still another preferred embodiment of the present invention.

FIG. 9 is an enlarged perspective view similar to FIG. 5 showing the ratchet sliding wheel spring structure shown in FIG. 8.

FIG. 10 is a plane diagram similar to FIG. 1 showing a part of a hand-wound timepiece according to yet still another preferred embodiment of the present invention which is provided with a hand-wound mechanism according to yet still another preferred embodiment of the present invention having a ratchet sliding wheel spring structure as a hand-wound timepiece return spring structure according to yet still another preferred embodiment of the present invention.

FIG. 11 is an enlarged perspective view similar to FIG. 5 showing the ratchet sliding wheel spring structure shown in FIG. 10.

FIG. 12 is a plane diagram similar to FIG. 1 showing a part of a conventional hand-wound timepiece which is provided with a conventional hand-wound mechanism having a ratchet sliding wheel spring as a conventional hand-wound timepiece return spring structure.

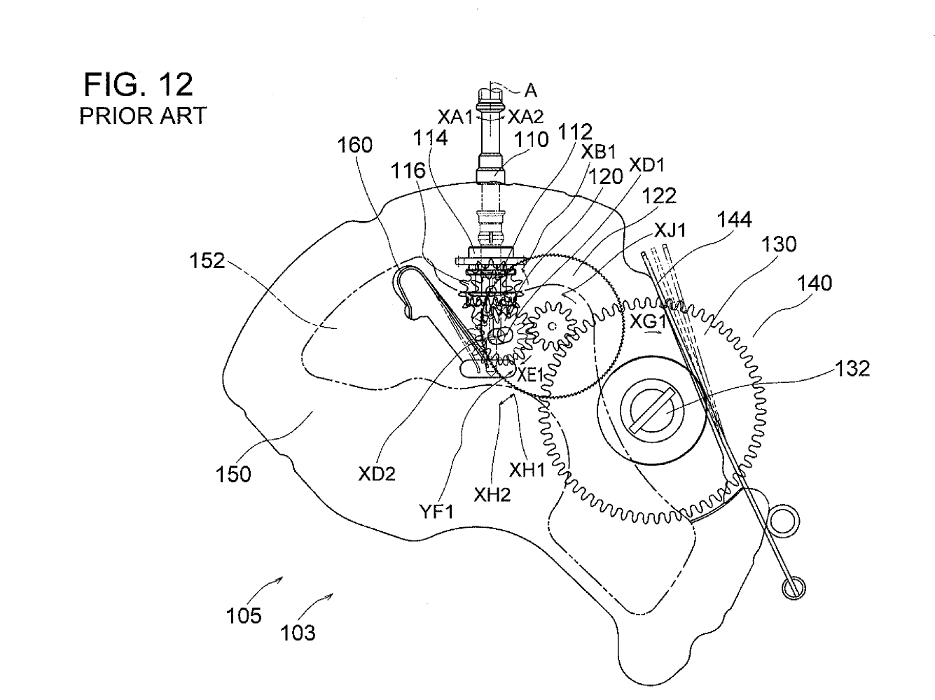

FIG. 13A to FIG. 13C are cross-sectional views showing a part of the conventional hand-wound timepiece shown in FIG. 12. FIG. 13A is a cross-sectional view similar to FIG. 2A showing a ratchet sliding wheel spring, a ratchet sliding wheel, and a second transmitting wheel in the hand-wound mechanism of the conventional hand-wound timepiece shown in FIG. 12. FIG. 13B is a cross-sectional view similar to FIG. 2B showing a arrangement state of the ratchet sliding wheel spring in the hand-wound mechanism of the conventional hand-wound timepiece shown in FIG. 12. FIG. 13C is a cross-sectional view similar to FIG. 2D showing a part of the conventional hand-wound timepiece shown in FIG. 12.

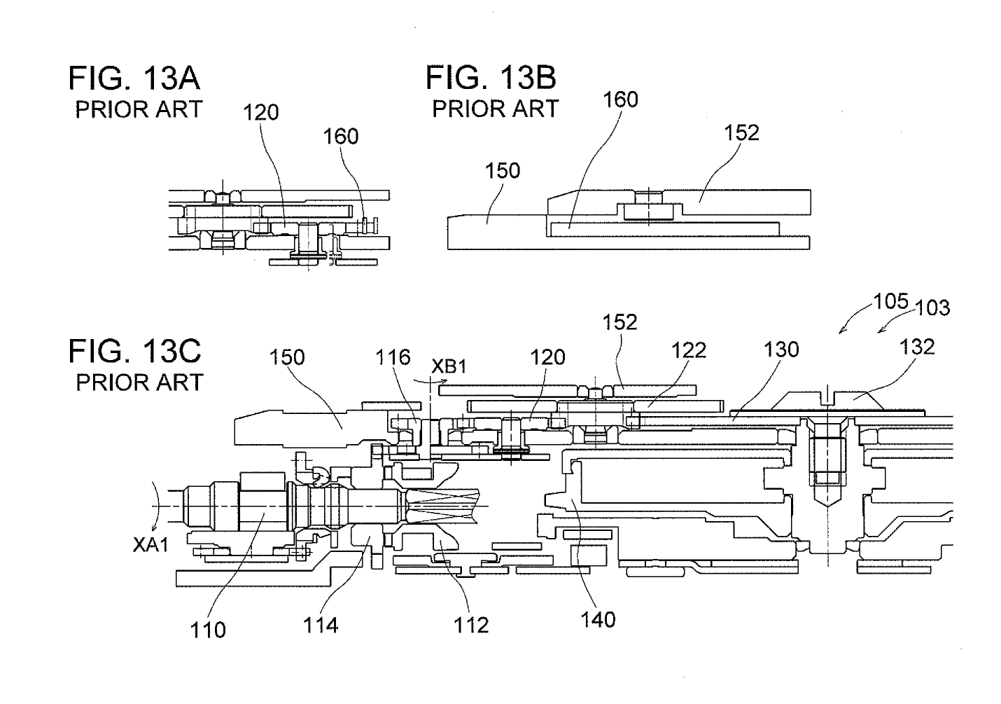

FIG. 14 is a perspective view similar to FIG. 3 showing the hand-wound mechanism of the conventional hand-wound timepiece shown in FIGS. 12 and 13A to 13C.

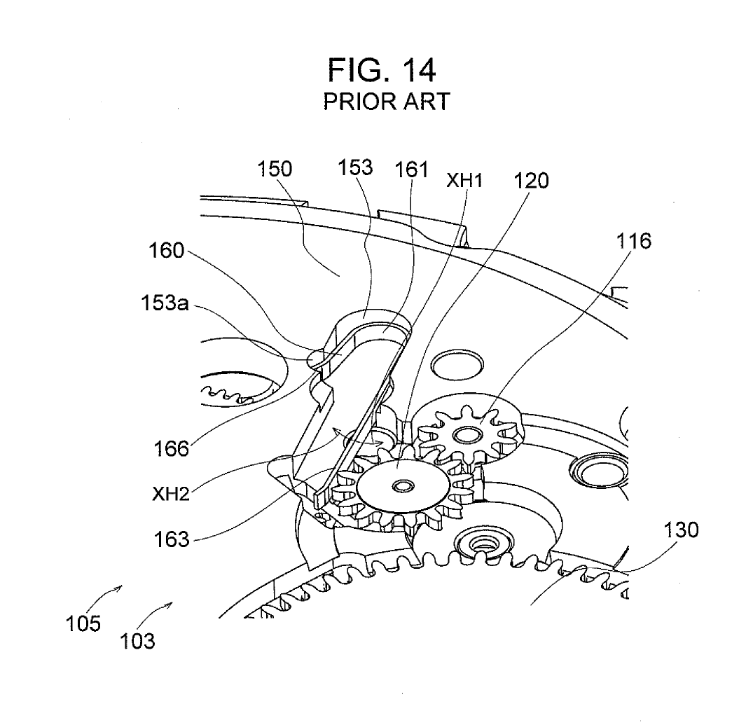

FIG. 15 is an enlarged perspective view similar to FIG. 5 showing the conventional ratchet sliding wheel spring shown in FIG. 12.

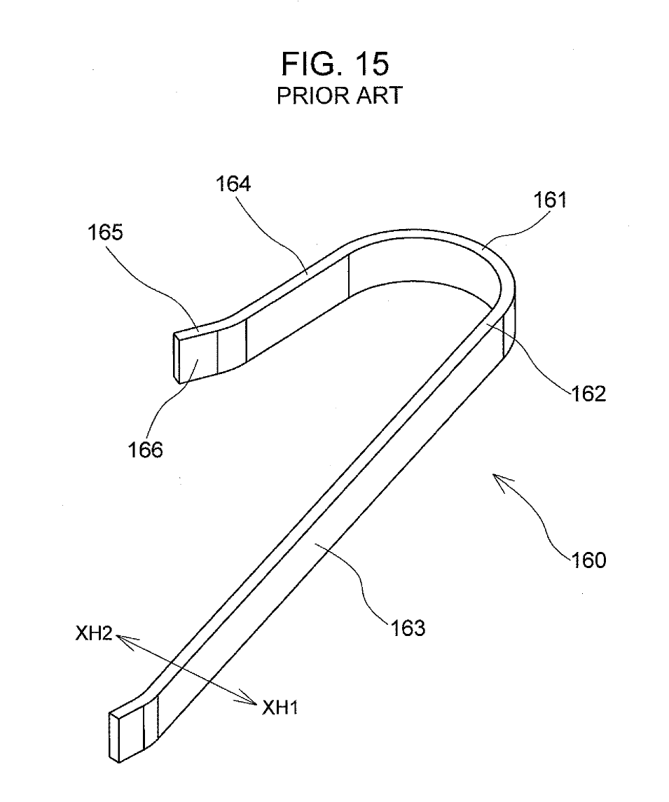

### DETAILED DESCRIPTION OF THE PREFERRED EMBODIMENTS

Some preferred embodiments according to the present invention will be described with reference to the accompanying drawings showing preferred examples.

### Embodiment

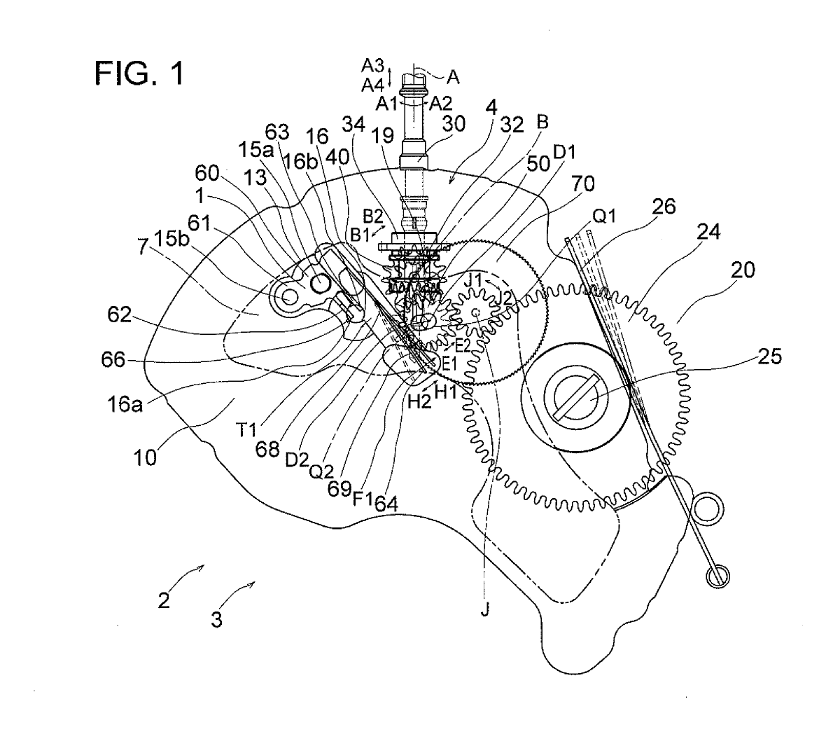

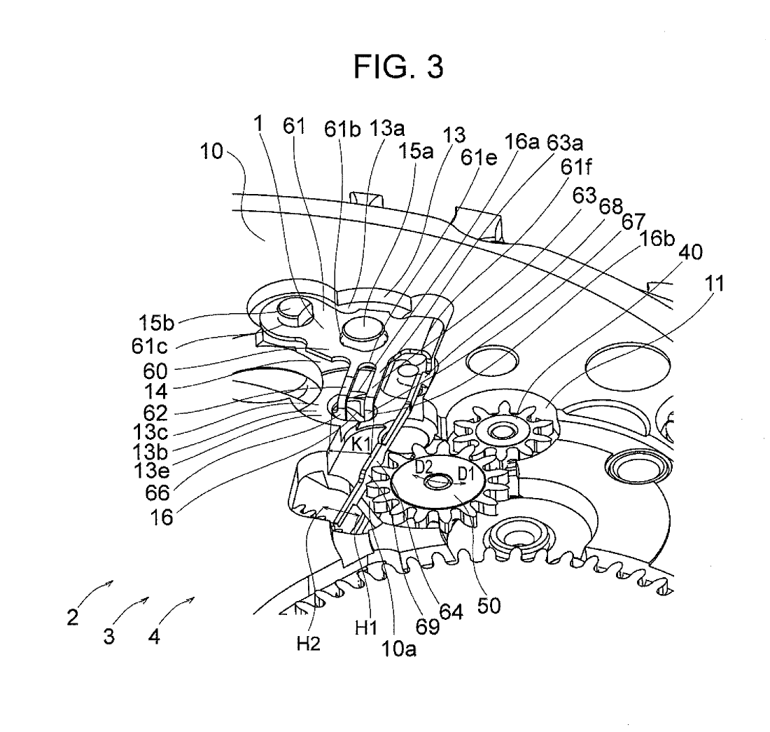

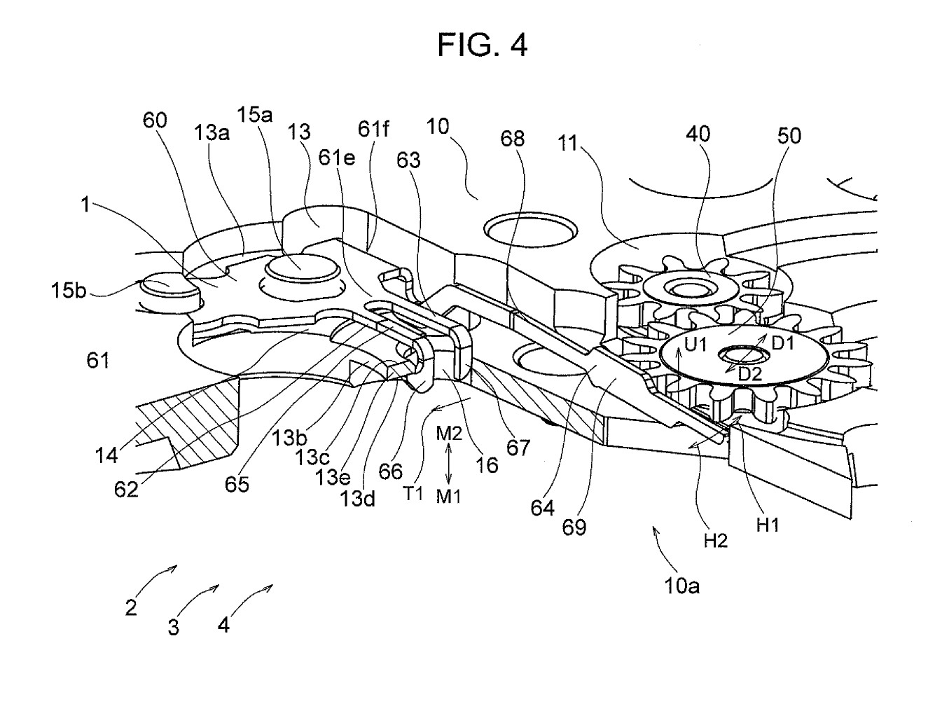

FIGS. 1 to 5 show a hand-wound timepiece 3 according to a first embodiment of the present invention which includes a hand-wound mechanism 2 according to the first embodiment of the present invention having a ratchet sliding wheel spring structure 1 as a hand-wound timepiece return spring structure according to the first embodiment of the present invention.

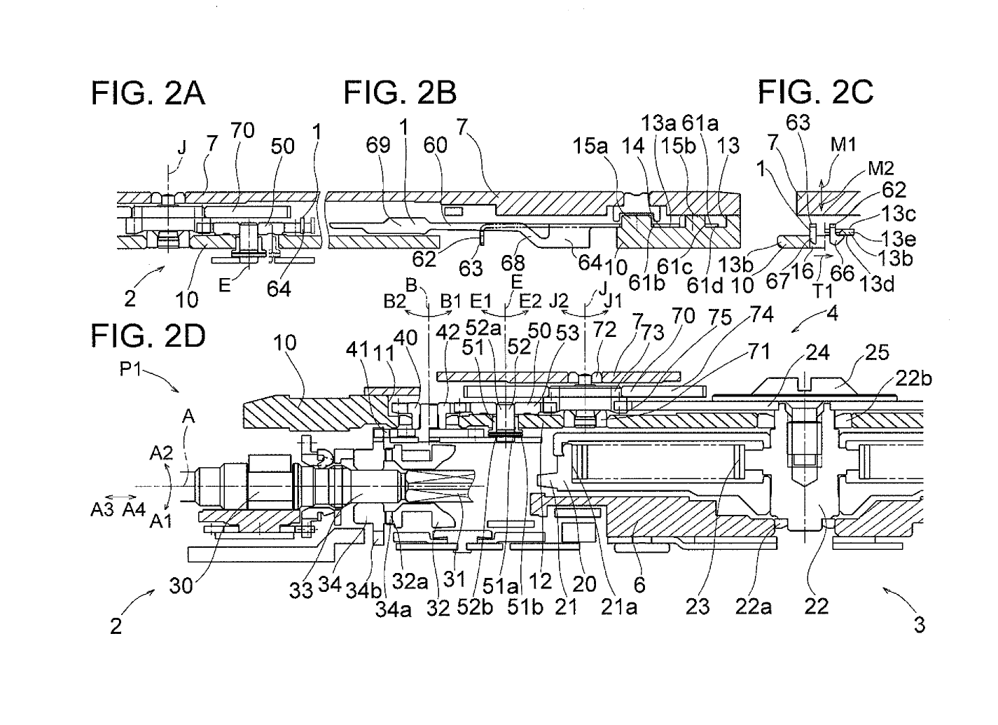

As seen from FIG. 2D and FIG. 2A, the hand-wound timepiece 3 includes a main plate 6 serving as a main support substrate, a first wheel bridge 10, and an automatic train wheel bridge 7. In addition, the hand-wound timepiece 3 also includes an automatically wound mechanism (not shown), and thus is configured as a hand-wound timepiece in which automatic winding is also possible (as a automatically wound timepiece in which manual winding is also possible).

A movement barrel 20 is arranged between the main plate 6 and the first wheel bridge 10. The movement barrel 20 includes a movement barrel tooth portion 21, a barrel arbor 22, a mainspring 23, and a ratchet wheel 24. The spiral mainspring 23 is engaged by friction with an inner peripheral wall 21a of the movement barrel tooth portion 21 at the outer peripheral end thereof and is attached to the barrel arbor 22 at the inner peripheral end thereof. The ratchet wheel 24 is fixed to the barrel arbor 22 by a ratchet wheel screw 25 on the case back side of the first wheel bridge 10. The barrel arbor 22 is rotatably supported by the main plate 6 and the first wheel bridge 10 through bearing portions 22a and 22b. Reference numeral 26 represents a click.

In the main plate 6, a winding stem 30 is arranged so as to rotate about a center axis line A in A1 and A2 directions and so as to advance and retreat parallel to a direction extending from the center axis line A and in A3 and A4 directions. A clutch wheel 32 is fitted into a prism portion 31 of the winding stem 30 so as to rotate together with the winding stem 30 in the A1 and A2 directions. A winding pinion 34 is fitted to a columnar portion 33 of the winding stem 30. When the winding stem 30 is in a normal needle-handling position P1 of being inserted in the A4 direction, ratchet tooth portions 34a and 32a, which face each other, of the winding pinion 34 and the clutch wheel 32 mesh with each other. When the winding stein 30 rotates in the A1 direction, the clutch wheel 32 and the winding pinion 34 also rotate in the A1 direction. In addition, when the winding stem 30 rotates in the A2 direction, the rotation of the clutch wheel 32 in the A2 direction is not transmitted to the winding pinion 34, and idling is caused between the clutch wheel 32 and the winding pinion 34.

Most parts of the hand-wound mechanism or hand-wound mechanism main body portion 4 is arranged between the first wheel bridge 10 and the automatic train wheel bridge 7.

The hand-wound mechanism main body portion 4 includes a crown wheel structure 40, the ratchet sliding wheel spring structure 1 as a ratchet sliding wheel structure 50 and a hand-wound timepiece return spring structure, and a second transmitting wheel structure 70.

As seen from FIG. 2D and FIG. 1, the crown wheel structure 40 includes a lower stage crown wheel 41 which is located on the main plate 6 side of the first wheel bridge 10 and an upper stage crown wheel 42 which is concentric to the lower crown wheel 41 and is located in a concave portion 11 on the automatic train wheel bridge 7 side of the first wheel bridge 10. The lower and upper stage crown wheels 41 and 42 rotate together about a common center axis line B in B1 and B2 directions. The lower stage crown wheel 41 meshes with an outer peripheral tooth portion 34b of the winding pinion 34. When the clutch wheel 32 and the winding pinion 34 rotate in the A1 direction along with the rotation of the winding stem 30 in the A1 direction, the lower stage crown wheel 41 rotates in the B1 direction and the upper stage crown wheel 42 also rotates together in the B1 direction.

The ratchet sliding wheel structure 50 includes a bearing portion 51, a shaft portion 52, and a ratchet sliding wheel tooth portion 53. The bearing portion 51 is rockably and freely fitted into an arc-like elongated hole 19 (FIG. 1) formed on a thin portion 12 in the concave portion 11 of the first wheel bridge 10 in extending directions or longitudinal directions of the arc-like elongated hole 19 D1 and D2. The arc forms a part of circle centering on the center axis line B. The bearing portion 51 includes a bearing main body portion 51a which is cylindrical and freely fitted into the elongated hole 19 and a flange portion 51b which is formed at one end of the bearing portion main body 51a on the main plate 6 side of the thin portion 12 of the first wheel bridge 10. The shaft portion 52 includes a columnar shaft main body portion 52a which is fitted into a cylindrical bearing main body portion 51a of the bearing portion 51 so as to slidably rotate about a center axis line E in E1 and E2 directions and a large diameter portion 52b which is located at one end of the shaft main body portion 52a. The large diameter portion 52b is located on the main plate 6 side of the flange portion 51b of the bearing portion 51. The ratchet sliding wheel tooth portion 53 is fitted into an end portion on the automatic train wheel bridge 7 side of the shaft main body portion 52a. That is, the ratchet sliding wheel structure 50 is freely fitted into the arc-like elongated hole 19 of the first wheel bridge 10 through the bearing portion 51 in a state of being interposed between the large diameter portion 52b on one end side of the shaft portion 52 and the flange portion 51b of the bearing portion 51b and the ratchet sliding wheel tooth portion 53 on the other end side of the shaft portion 52.

Therefore, the ratchet sliding wheel structure 50 is rockable in the D1 and D2 direction between a meshing position Q1 in which the main body 51a, into which the main body 52a of the shaft portion 52 is fitted, of the bearing 51 is biased in the D1 direction and a non-meshing position Q2 in which the main body 51a of the bearing 51 is biased in the D2 direction.

As described below, the ratchet sliding wheel structure 50 receives an elastic biasing force F1 in the D1 direction due to the ratchet sliding wheel spring structure 1 as a hand-wound return spring structure.

The second transmitting wheel structure 70 includes a shaft portion 73 which is supported by a bearing portion 71 of the first wheel bridge 10 and a bearing portion 72 of the automatic train wheel bridge 7 so as to rotate about a center axis line J in J1 and J2 directions and a second transmitting wheel tooth portion 74 and a second transmitting pinion portion 75 which are attached to the shaft portion 73. The second transmitting wheel tooth portion 74 meshes with a train wheel (not shown) of the automatically wound mechanism (not shown). The second transmitting pinion portion 75 meshes with the ratchet wheel 24. Therefore, the second transmitting wheel structure 70, on one hand, transmits the rotation of the automatic train wheel (not shown) along with the rotation of the oscillating weight which is not shown in the drawing to the ratchet wheel 24. Accordingly, the main spring 23 can be automatically wound through the ratchet wheel 24.

When the ratchet sliding wheel structure 50 rocks to the position Q1 of being biased in the D1 direction, the ratchet sliding wheel tooth portion 53 of the ratchet sliding wheel structure 50 can mesh with the second transmitting pinion portion 75 of the second transmitting wheel structure 70. When the second transmitting wheel tooth portion 74 rotates in the J1 direction due to the operation of the automatically wound mechanism (not shown) and the ratchet sliding wheel structure 50 rocks to the position Q2 of being biased in the D2 direction, the meshing between the ratchet sliding wheel tooth portion 53 of the ratchet sliding wheel structure 50 and the second transmitting pinion portion 75 of the second transmitting wheel structure 70 is released.

Before describing the ratchet sliding wheel spring structure 1 as a hand-wound timepiece return spring structure in detail, a portion of the first wheel bridge 10 in which the ratchet sliding wheel spring structure 1 is arranged will be described.

The first wheel bridge 10 includes a ratchet sliding wheel spring arrangement concave portion 13 which is connected to the concave portion 11 through an area 10a. In a bottom surface portion 13a of the concave portion 13, a plane bottom portion 14 and convex portions 15a and 15b protruding from the bottom portion 14 are formed. In addition, an opening 16 is formed in a locking plate-like portion 13b slightly away from the bottom portion 13a. The opening 16 penetrates the locking plate-like portion 13b and connects a surface 13c on the front side and a surface on the rear side, that is, a back surface 13d of a wall 13e which forms the plate-like portion 13b to define the opening 16.

A spring member 60 which is made of a cut and bent portion of alloy plate spring and configures the ratchet sliding wheel spring structure 1 as a hand-wound timepiece return spring structure includes a plate-like placement portion 61, a forced insertion hooking spring portion 62, a positioning spring portion 63, and a return spring 64.

The plate-like placement portion 61 includes a plate-like main body 61a. Positioning openings 61b and 61c are formed in the plate-like main body portion 61a. The spring member 60 is placed in the bottom surface portion 13a of the concave portion 13 such that the plate-like main body portion 61a configuring the plate-like placement portion 61 comes into contact with the plane bottom portion 14 of the concave portion 13 of the first wheel bridge 10 at a back surface 61d and such that the convex portions 15a and 15b of the bottom portion 14 are fitted into the positioning openings 61b and 61c of the plate-like main body portion 61a.

The forced insertion hooking spring portion 62 includes a forced insertion hooking spring arm portion 65 and a forced insertion locking end portion 66. The hooking spring arm portion 65 includes a rear anchor side arm portion 65b which connects to one edge portion 61e of the plate-like main body portion 61a at a rear anchor portion 65a and extends from the rear anchor portion 65a and a forward end side arm portion 65d which is bent approximately perpendicular to a forward end portion 65c of the rear anchor side arm portion 65b and extends. The forced insertion locking end portion 66 includes a locking protrusion 66a which horizontally extends from the forward end portion of the forward end side arm portion 65d. In the lower edge side of the locking protrusion 66a, an inclined guide surface 66b is formed as a forced insertion guide inclination surface. In the upper side, a locking surface 66c which approximately horizontally extends is formed as a forced insertion locking surface. When the openings 61b and 61c of the plate-like placement portion 61 are fitted into the convex portions 15a and 15b of the plate-like bottom portion 14 of the concave portion 13, the rear anchor side arm portion 65b and the forward end side arm portion 65d have a length such that the locking protrusion 66a forming the forced insertion locking end portion 66 directly faces the opening 16 of the plate-like portion 13b.

The positioning spring portion 63 includes a positioning spring arm portion 63a and a forced insertion engagement end portion 67. The positioning spring portion 63 is located opposite to a side of the forced insertion hooking spring portion 62 where the locking protrusion 66a configuring the forced insertion locking end portion 66 protrudes. The positioning spring arm portion 63a includes a rear anchor side arm portion 63c which is connected to the edge portion 61e of the plate-like main body portion 61a in the rear anchor portion 63b and extends parallel to the rear anchor side arm portion 65b of the forced insertion hooking spring arm portion 65 from the rear anchor portion 63b. The forced insertion engagement end portion 67 includes a forward end side arm portion 67a which is bent approximately perpendicular to the forward end portion 63d of the rear anchor side arm portion 63c and extends. The forced insertion engagement end portion 67 includes a curved inclination guide surface 67c at the forward end portion of one edge 67b opposite to a side facing the forward end side arm portion 65d of the forced insertion hooking spring portion 62. When the openings 61b and 61c of the plate-like placement portion 61 are fitted into the convex portions 15a and 15b of the plate-like bottom portion 14 of the concave portion 13, the rear anchor side arm portion 63c has a length such that the forward end side arm portion 67a forming the forced insertion engagement end portion 67 on the forward end side directly faces a front side edge portion 16a and a edge portion 16b, which is opposite to the side where there is the forced insertion hooking spring arm portion 65, of the opening 16 of the plate-like portion 13b.

In a state immediately before the ratchet sliding wheel spring structure 1 is assembled into the concave portion 13 of the first wheel bridge 10, a space W1 between an outer edge 65f of the forward end side arm portion 65d of the forced insertion hooking spring portion 62 and an outer edge 67b of the forced insertion engagement end portion 67 on the forward end side of the positioning spring portion 63 is larger than a width K1 of the opening 16.

The return spring 64 includes a return spring arm portion 68 which is adjacent to the edge 61e in the plate-like main body 61a forming the plate-like placement portion 61, is opposite to the surface where the protrusion 66a of the forced insertion hooking spring portion 62 protrudes, and is connected to an edge 61f and a pressing portion 69 which is formed on the forward end side of the return spring arm potion 68. The return spring arm potion 68 includes a rear anchor portion 68a which is connected to the edge 61f of the plate-like main body portion 61a and is bent approximately perpendicular to the edge 61f and a return spring arm main body portion 68b which extends on a plane approximately parallel to the rear anchor side arm portion 65b of the hooking spring arm potion 65 of the forced insertion hooking spring portion 62 and the positioning spring arm portion 63a of the positioning spring portion 63 from the rear anchor portion 68a. In addition, in order to lower constant of spring, the return spring arm main body portion 68b includes a rear anchor side return spring arm main body portion 68c and a forward end side return spring arm main body portion 68d which are bent in the extending surface so as to secure a length of the arm. The pressing portion 69 includes an elongated portion 69a which is connected to the forward end side of the forward end side return spring arm main body portion 68d in the return spring arm main body portion 68b and has a relatively wide width. Therefore, the return spring portion 64 is elastically and flexibly deformable in H2 and H1 directions such that the pressing portion 69 approaches or is separated from the positioning spring portion 63 or the forced insertion hooking spring portion 62.

In the ratchet sliding wheel spring structure 1 as a hand-wound return spring structure which is configured as above, in a state immediately before mounting the automatic train wheel bridge 7 and a state where a train wheel or the like configuring the hand-wound mechanism 2 is assembled in the first wheel bridge 10, when an area including the plate-like placement portion 61 and the forced insertion hooking spring portion 62, and the positioning spring portion 63 (several mm² of area) is inserted by a finger or the like in a state where the ratchet sliding wheel spring structure 1 is arranged in a predetermined position such that the openings 61b and 61c of the plate-like main body portion 61a of the plate-like placement portion 61 are fitted into the convex portions 15a and 15b of the concave portion 13 of the first wheel bridge 10, the forced insertion engagement end portion 67 of the positioning spring portion 63 of the approximately positioned ratchet sliding wheel spring structure 1 is inserted into the opening 16 in a M1 direction along the edge portion 16a and 16b of the opening 16 by the fitting between the openings 61b and 61c of the plate-like placement portion 61 and the convex portions 15a and 15b of the first wheel bridge 10. In addition, the forced insertion locking end portion 66 of the forced insertion hooking spring portion 62 of the ratchet sliding wheel spring structure 1 is also inserted along the edge portions of the opening 16. Here, in a case where the forced insertion hooking spring portion 62 is inserted along the edge portions of the opening 16 of the forced insertion locking end portion 66, the forced insertion locking end portion 66 is elastically displaced in the M1 direction during the insertion along the inclined guide surface 66b of the front edge side. When the locking protrusion 66a reaches the back surface 13d of the wall 14 defining the opening 16, the locking surface 66c of the forced insertion locking end portion 66 comes into contact with the back surface 13d of the wall 14. At this time, the locking surface 66c of the forced insertion locking end portion 66 is pressed against the back surface 13d of the wall 14 by an elastic force of returning the hooking spring arm portion 65, which is curved in the M1 direction to some extent, of the forced insertion hooking spring portion 62 to a M2 direction. In addition, since the edge 67b of the forced insertion engagement end portion 67 of the positioning spring portion 63 receives a force in a T1 direction from the edge portion 16b of the opening 16, the edge portion 65f where there is the forced insertion locking end portion 66 is also pressed in the T1 direction against the edge facing the opening 16. As a result, even an unexpected force is applied, the forced insertion locking end portion 66 is maintained in a state where there is less concern of being removed from the wall 13e of the opening 16.

In addition, after finishing the mounting, the return spring portion 65 may be curved in the H2 direction and the pressing portion 69 may be retreated in the H2 direction or D2 direction from the ratchet sliding wheel structure 50 to be in contact with the outer periphery of the ratchet sliding wheel tooth portion 53 of the ratchet sliding wheel structure 50 and be pressed. In this way, the ratchet sliding wheel spring structure 1 applies the biasing force F1 to the ratchet sliding wheel tooth portion 53 of the ratchet sliding wheel structure 50 in the D1 direction by the return spring portion 64 in a state of being mounted into the concave portion 13 of the first wheel bridge 10.

Here, when the ratchet sliding wheel spring structure 1 is mounted on a predetermined position, the position and the posture of the ratchet sliding wheel spring structure 1 with respect to the first wheel bridge 10 of the plate-like placement portion 61 can be maintained constant in practice by the positioning spring portion 63 and the forced insertion hooking spring portion 62. That is, in the ratchet sliding wheel spring structure 1, the position and the posture of the ratchet sliding wheel spring structure 1 with respect to the first wheel bridge 10 of the plate-like placement portion 61 can be maintained constant in practice regardless of the rocking position or bending position of the pressing portion 69 of the return spring portion 64 in the H1 and H2 directions.

Therefore, even when the ratchet sliding wheel structure 50 retreats to the non-meshing position Q2, the hand-wound mechanism 2 having the ratchet sliding wheel spring structure 1 reliably receives a biasing force to the meshing position Q1 through the return spring portion 64. Accordingly, the meshing between the ratchet sliding wheel structure 50 and the second transmitting wheel 70 during the hand-winding can be reliably performed.

In addition, even when the hand-wound mechanism 2 receives a force in which the forward end side of the pressing portion 69 of the return spring portion 64 rocks to the case back side in a U1 direction, the locking protrusion 66a prevents the plate-like placement portion 61 from being displaced in the U1 direction. Therefore, even when the hand-wound mechanism 2 receives such an unexpected external force as a small impact, there is less concern that the ratchet sliding wheel spring structure 1 may be removed. Thereafter, the assembly is completed after mounting the automatic train wheel bridge 7 or the like.

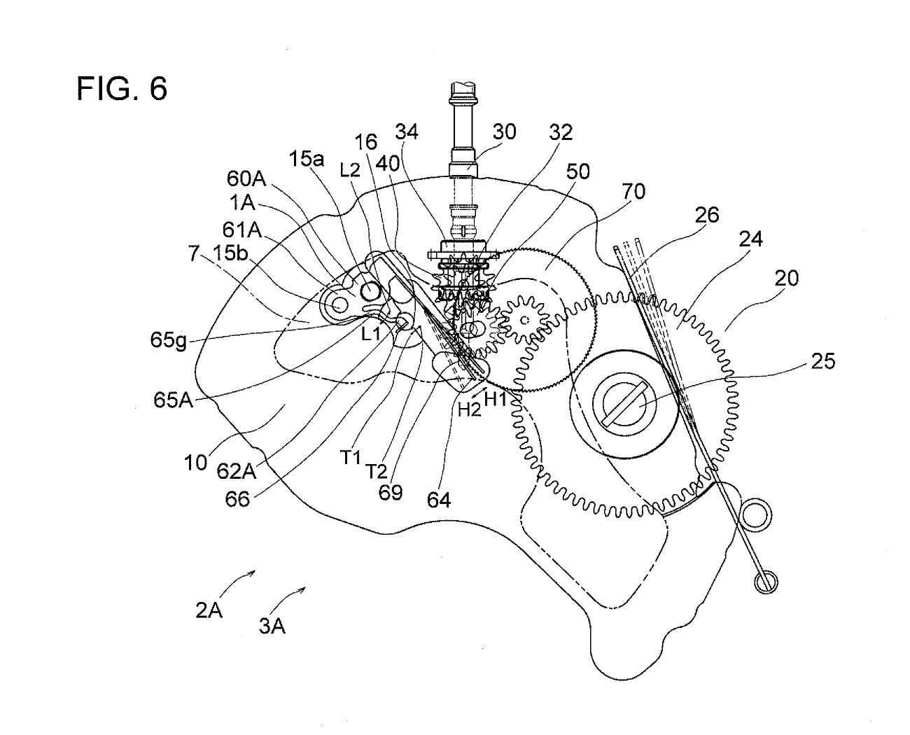

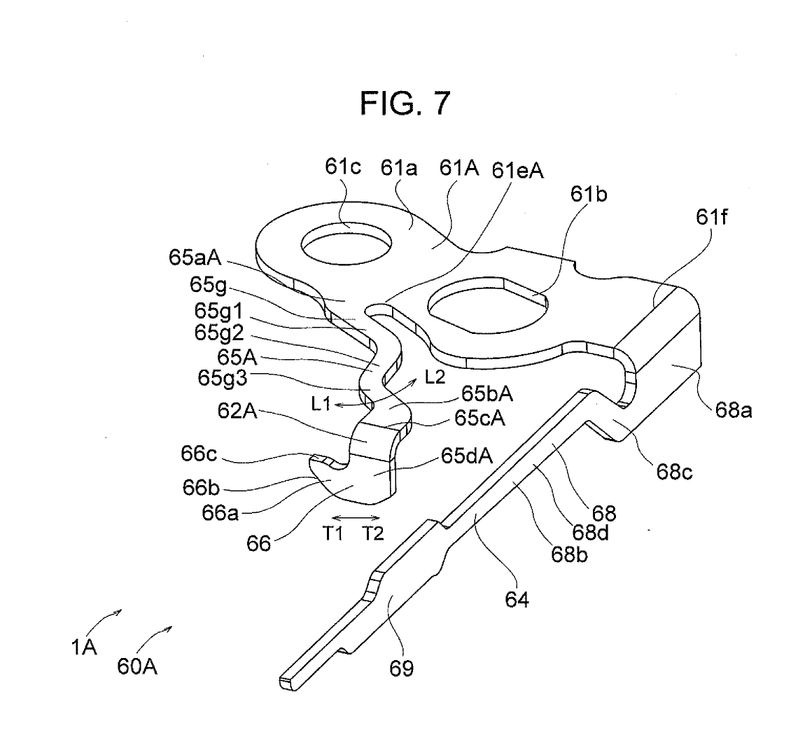

The ratchet sliding wheel spring structure as a hand-wound timepiece return spring structure may not be provided with the positioning spring portion. According to another preferred embodiment of the present invention shown in FIGS. 6 and 7, the same reference numerals are given to the same components as those shown in FIGS. 1 to 5. Components in FIGS. 6 and 7 which approximately correspond to those in FIGS. 1 to 5 but have different points add A after the same reference numerals.

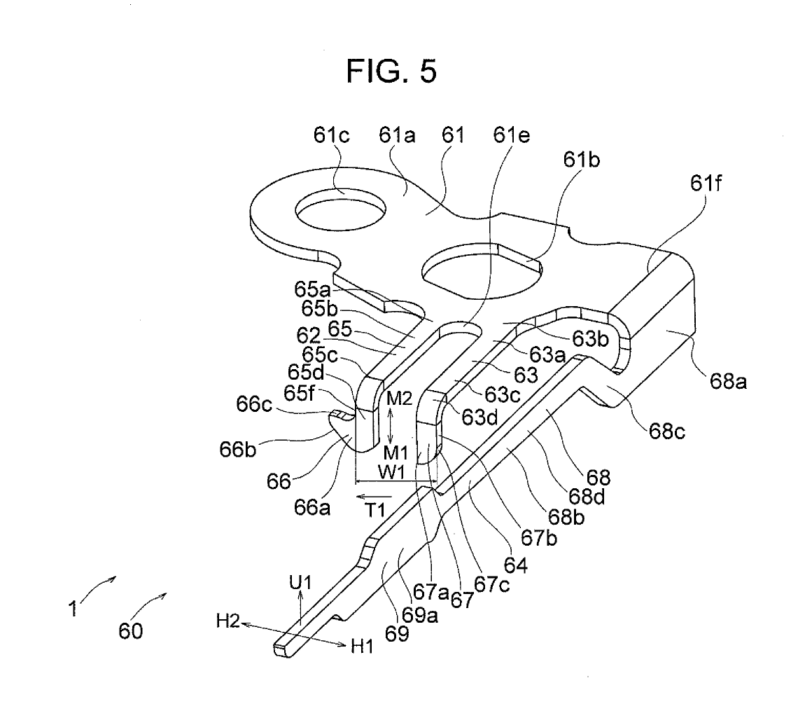

As shown in FIG. 7, a ratchet sliding wheel spring structure 1A according to another preferred embodiment of the present invention is the same as the ratchet sliding wheel spring structure 1 shown in FIG. 5 in that a plate-like placement portion 61A, a forced insertion hooking spring portion 62A, and the return spring portion 64 are provided, but is different from the ratchet sliding wheel spring structure 1 shown in FIG. 5 in that the positioning spring portion 63 is cut out and the forced insertion hooking spring portion 62A has a different shape or structure as that of the forced insertion spring portion 62. In addition, the plate-like placement 61A also can have a different shape to some extent such that the forced insertion hooking spring portion 62A has an appropriate shape. A hand-wound timepiece 3A according to another preferred embodiment of the present invention having a hand-wound mechanism 2A according to another preferred embodiment of the present invention shown in FIG. 6 is different from the hand-wound timepiece 3 having the hand-wound mechanism 2 shown in FIG. 1 in that the ratchet sliding wheel spring structure 1A instead of the ratchet sliding wheel spring structure 1.

In the ratchet sliding wheel spring structure 1A which is made of a spring member 60A in the form of bent plate body shown in FIGS. 7 and 6, the forced insertion hooking spring body 62A includes a forced insertion hooking spring arm portion 65A and the forced insertion locking end portion 66. The hooking spring arm portion 65A is connected to one edge portion 61eA of a plate-like placement portion 61a at a rear anchor portion 65aA, and includes a rear anchor side meandering arm portion 65g which extends from the rear anchor portion 65aA meandering in a Z-shape, an rear anchor side vertical arm portion or intermediate arm portion 65bA which changes the direction from an extending end of the rear anchor side meandering arm portion 65g and extends approximately parallel to the return spring portion 64, and a forward end side arm portion 65dA which is bent approximately perpendicular to a forward end 65cA of the rear anchor side vertical arm portion 65bA and extends. In the example shown in the drawing, the rear anchor side meandering arm portion 65g includes a first arm portion 65g1 which extends to the return spring portion 64, a second arm portion 65g2 which changes the direction from the forward end of the first arm portion 65g1 and extends approximately parallel to the return spring portion 64, and a third arm portion 65g3 which changes the direction from the forward end of the second arm portion 65g2 and extends again to the return spring portion 64. The forced insertion locking end portion 66 includes a locking protrusion 66a which horizontally extends from the forward end portion of the forward end side arm portion 65dA. In the lower edge side of the locking protrusion 66a, a inclined guide surface 66b is formed as a forced insertion guide inclination surface. In the upper side, a locking surface 66c which approximately horizontally extends is formed as a forced insertion locking surface. The above points are the same as in the case of the forced insertion locking end portion 66 of the forced insertion hooking spring portion 62 of the ratchet sliding wheel spring structure 1.

Since the forced insertion hooking spring portion 62A (forced insertion hooking spring arm portion 65A thereof) is provided with the rear anchor side meandering arm portion 65g, the ratchet sliding wheel spring structure 1A can be rockable in L1 and L2 directions. In addition, the forced insertion hooking spring portion 62A easily rocks elastically in the T1 and T2 directions at the forced insertion hooking spring arm portion 65A as compared to the forced insertion hooking spring portion 62 (forced insertion hooking spring arm portion 65 thereof) of the ratchet sliding wheel spring structure 1. Therefore, even when the positioning spring portion 63 is not provided independently, the forced insertion hooking spring portion 62A is pressed in the T1 direction against an opposite side edge of the opening 16 of the first wheel bridge 10 through the forced insertion locking end 66 by an elastic force of the forced insertion hooking spring arm portion 65A in the T1 and T2 directions.

Since the ratchet sliding wheel spring structure 1A is also provided with the plate-like placement portion 61A and the forced insertion hooking spring portion 62A, the mounting on the first wheel bridge 10 can be easily and reliably performed and the concern that the ratchet sliding wheel structure 1A may be removed from the first wheel bridge 10 can be suppressed low.

In the ratchet sliding wheel spring structure 1A, since the positioning spring portion 63 of the ratchet sliding wheel spring structure 1 is cut out, the locking operation due to the forced insertion hooking spring portion 62A may vary depending on the rocking position of the return spring portion 64A in the H1 and H2 directions.

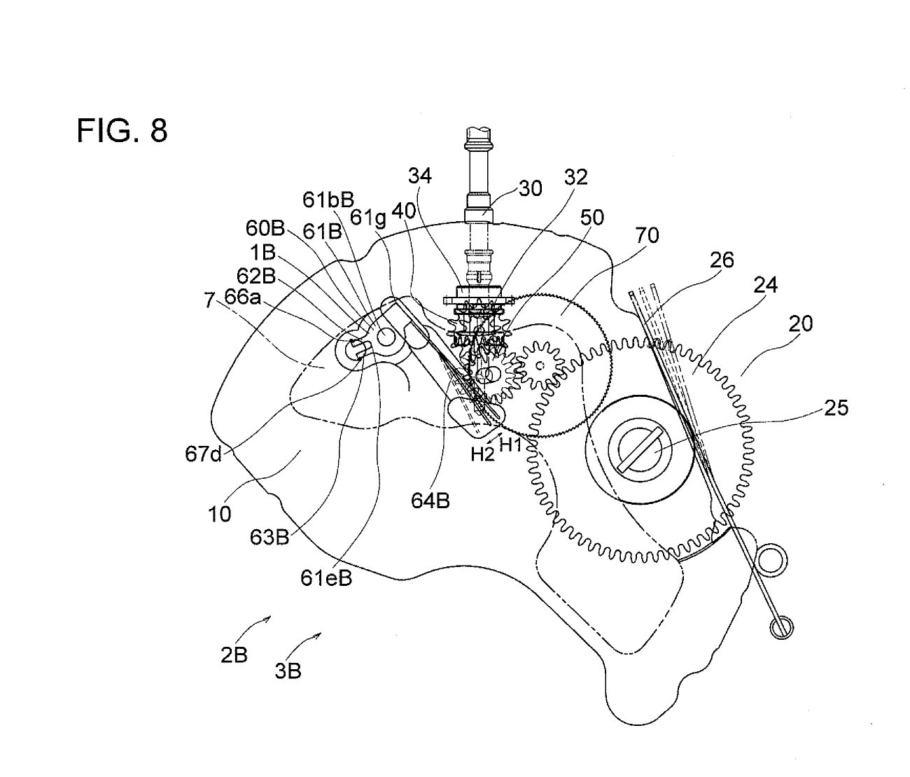

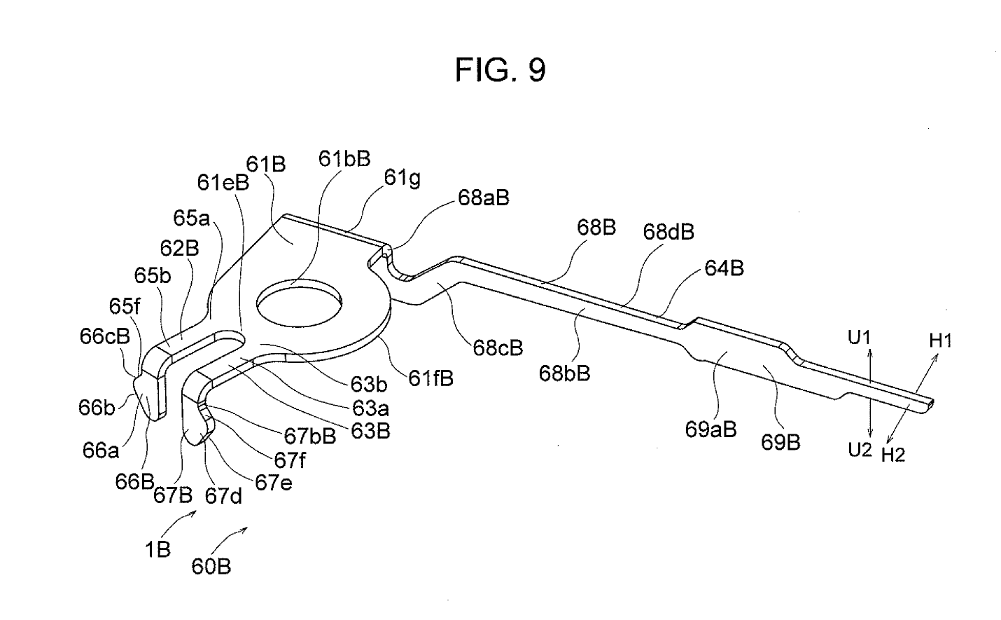

In the ratchet sliding wheel spring structure as a hand-wound timepiece return spring structure, the forced insertion hooking spring portion, the positioning spring portion, and the return spring portion may extend in different directions instead of the same directions (approximately parallel). According to still another preferred embodiment of the present invention shown in FIGS. 8 and 9, the same reference numerals are given to the same components as those shown in FIGS. 1 to 5. Components in FIGS. 8 and 9 which approximately correspond to those in FIGS. 1 to 5 but have different points add B after the same reference numerals.

As shown in FIG. 9, a ratchet sliding wheel spring structure 1B according to still another preferred embodiment of the present invention is different from the ratchet sliding wheel spring structure 1 shown in FIGS. 1 to 5, in that a return spring portion 64B extends in a direction intersecting, more specifically, approximately perpendicular to extending directions of a hooking spring portion 62B and a positioning spring portion 63B instead of extending approximately parallel to the forced insertion hooking spring portion and the positioning spring portion.

More specifically, as shown in FIG. 9, in the ratchet sliding wheel spring structure 1B which is made of a spring member 60B in the form of bent plate body, the return spring portion 64B is not connected to an edge portion 61fB, which is adjacent to an edge portion 61eB to which rear anchor portions 65a, 63b are connected of the forced insertion hooking spring portion 62B and the positioning spring portion 63B but connected to an edge portion 61g on the opposite side, in a plate-like placement portion 61B.

Here, the shape and the structure of the return spring portion 64B are the same as those of the return spring portion 64 in practice. That is, the return spring 64B includes a return spring arm portion 68B which is connected to the edge 61g of the plate-like placement portion 61B and a pressing portion 69 which is formed on the forward end side of the return spring arm potion 68B. The return spring arm potion 68 includes a rear anchor portion 68aB which is bent approximately perpendicular to the edge 61g and a return spring arm main body portion 68bB which extends approximately perpendicular to the rear anchor side arm portion 65b of the forced insertion hooking spring portion 62B and the positioning spring arm portion 63a of the positioning spring portion 63B from the rear anchor portion 68aB. The return spring arm main body portion 68bB includes a rear anchor side return spring arm main body portion 68cB and a forward end side return spring arm main body portion 68dB which are bent in the extending surface. A pressing portion 69 includes an elongated portion 69aB which is connected to the forward end side of the forward end return spring arm main body portion 68dB in the return spring arm main body portion 68bB and has a relatively wide width. Therefore, the return spring portion 64B is elastically and flexibly deformable in the H2 and H1 directions such that the pressing portion 695 rocks.

In the positioning spring portion 63B, unlike the positioning spring portion 63 shown in FIGS. 1 to 5, when an external force is applied to the return spring portion 64B in the U1 direction (FIG. 9), a forced insertion engagement end portion 67B has a protrusion 67d, which is the same as the protrusion 66, in an outer peripheral edge 67bB in order to regulate the plate-like placement portion 61B from rotating in the U1 direction. More specifically, the protrusion 67d of the forced insertion engagement end portion 67B of the positioning spring portion 63B includes a inclined guide surface 67e which is the same as the guide surface 66b of the protrusion 66a (although inclined reversely) and a locking surface or guide locking surface 67f which is approximately the same as the locking surface 66c of the protrusion 66a but inclined instead of horizontally extending.

In addition, since the protrusion 67d of the forced insertion engagement end portion 673 of the positioning spring portion 63B has the guide locking surface 67f, a protrusion 66B of the forced insertion hooking spring portion 62B also has an locking guide surface 66cB which is inclined instead of horizontally extending in order to enable the forced insertion hooking spring portion 62B to be removed.

In addition, in the ratchet sliding wheel spring structure 1B, since the relative arrangement and the shapes (structures) of the forced insertion hooking spring portion 62B, the positioning spring portion 63B, and the return spring portion 64B which are described above are different to some extent from the corresponding parts of the ratchet sliding wheel spring structure 1, the plate-like placement portion 61B also has a different shape from that of the plate-like placement portion 61. In this example, the plate-like placement portion 61B has one opening 61bB, not two.

A hand-wound timepiece 3B according to another preferred embodiment of the present invention having a hand-wound mechanism 2B according to another preferred embodiment of the present invention shown in FIG. 8 is different from the hand-wound timepiece 3 having the hand-wound mechanism 2 shown in FIG. 1, in that the ratchet sliding wheel spring structure 1B is provided instead of the ratchet sliding wheel spring structure 1.

In the ratchet sliding wheel spring structure 1B, since the both of the forced insertion hooking spring portion 62B and the positioning spring portion 63B have the protrusions 66a and 67d, the positioning spring portion 63B in addition to the forced insertion hooking spring portion 62B also can prevent the ratchet sliding wheel spring structure 1B from being removed. In this case, the edge portion 65f of the forced insertion hooking spring portion 623 exhibits the positioning function so as to make the locking due to the locking surface 67f of the protrusion 67d of the positioning spring portion 63B possible. That is, both of the forced insertion hooking spring portion 62B and the positioning spring portion 63B exhibit the functions of positioning and forced insertion hooking for each other.

In addition, in the ratchet sliding wheel spring structure 1B, since both of the forced insertion hooking spring portion 62B and the positioning spring portion 63B have the protrusion 66a and 67d which have the locking surfaces 66cB and 67f at the outer peripheral edge thereof, the return spring portion 64B extends in a direction not parallel to the forced insertion hooking spring portion 62B and the positioning spring portion 63B but perpendicular to the extending direction of the spring portions 62B and 63B. Accordingly, even when the holding force is weakened to some extent, the original portion of the ratchet sliding wheel spring structure 1B, that is, the plate-like placement portion 61B can be maintained at a predetermined position in the concave portion 13 of the first wheel bridge 10 against the external force in the U1 and U2 directions which is applied to the return spring 64B.

Furthermore, similar to a case of the ratchet sliding wheel spring structure 1A shown in FIG. 7 in which the positioning spring portion 62 is cut out in the ratchet sliding wheel spring structure 1 shown in FIG. 5, a ratchet sliding wheel spring structure 1C as a hand-wound timepiece return spring structure in which the positioning spring portion 62B is cut out in the ratchet sliding wheel spring structure 1B shown in FIG. 9 may be employed.

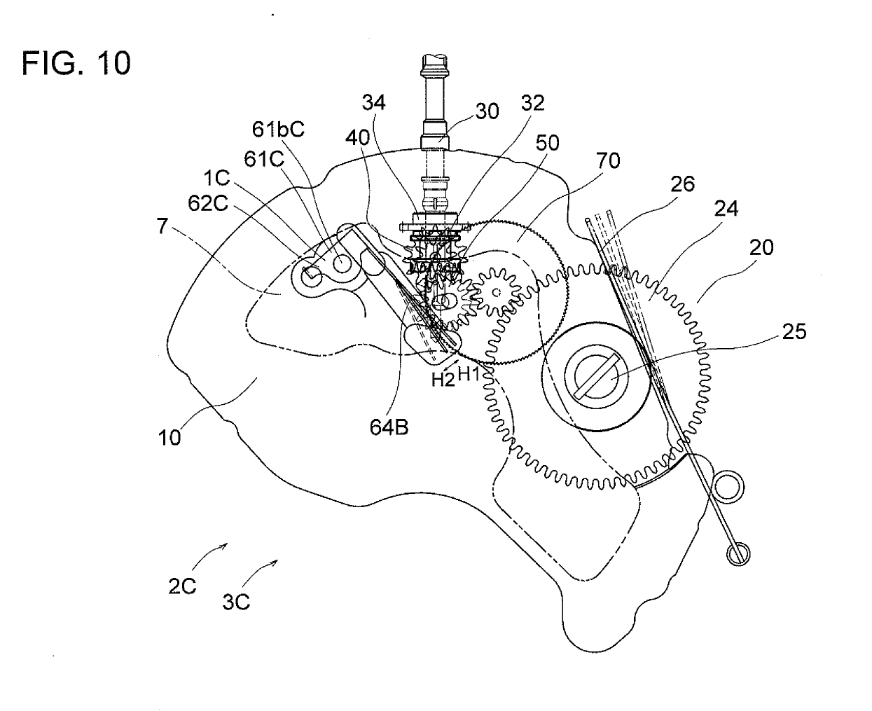

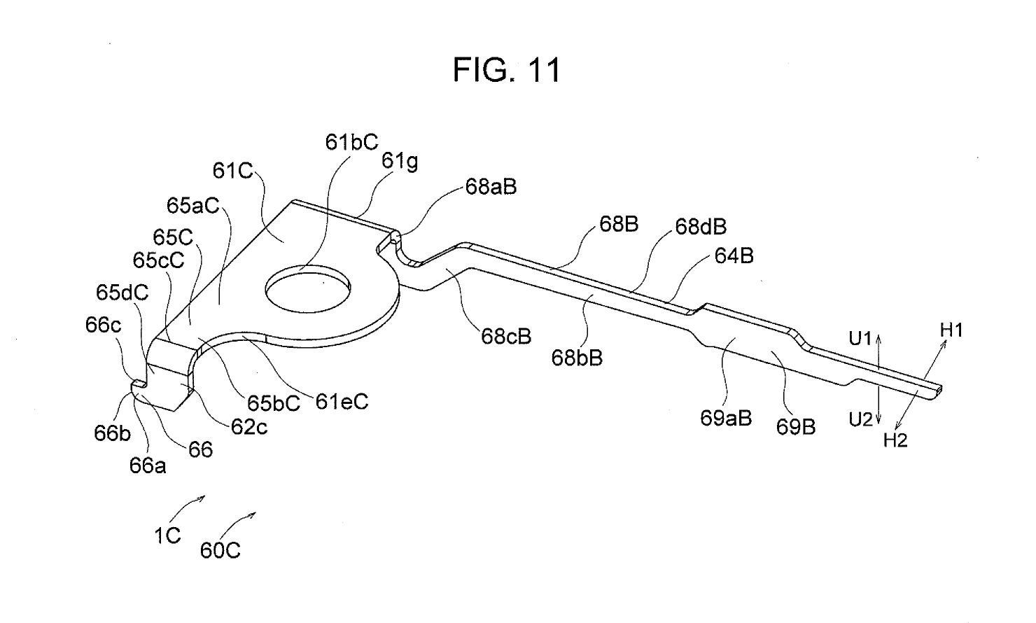

According to yet still another preferred embodiment of the present invention shown in FIGS. 10 and 11, the same reference numerals are given to the same components as those shown in FIGS. 1 to 5 and the same reference numerals are given to the same components as those shown in FIGS. 8 to 9 (the same shall be applied to the components where B is added at the last) . Components in FIGS. 10 and 11 which approximately correspond to those in FIGS. 8 to 9 but have different points add C after the same reference numerals (the reference numeral B is excluded in a case where B is located at the last).

As shown in FIG. 11, the ratchet sliding wheel spring structure 1C according to another preferred embodiment of the present invention is the approximately same as the ratchet sliding wheel spring structure 1B shown in FIG. 9, in that the plate-like placement portion 61C, the forced insertion hooking spring portion 62C, and the return spring portion 64B are provided, and is different from the ratchet sliding wheel spring structure 1B shown in FIG. 9, in that the positioning spring portion 63B is cut out and the forced insertion hooking spring portion 62C has a different shape or structure to some extent from those of the forced insertion hooking spring portion 62B. In addition, the plate-like placement portion 61C also can have a different shape to some extent such that the forced insertion hooking spring portion 62C has an appropriate shape and function. A hand-wound timepiece 3C according to still another preferred embodiment of the present invention having a hand-wound mechanism 2C according to still another preferred embodiment of the present invention shown in FIG. 10 is different from the hand-wound timepiece 3B having the hand-wound mechanism 2B shown in FIG. 8, in that the ratchet sliding wheel spring structure 1C is provided instead of the ratchet sliding wheel spring structure 1B.

In the ratchet sliding wheel spring structure 1C which is made of a spring member 60C in the form of bent plate body shown in FIGS. 11 and 10, the forced insertion hooking spring portion 62C includes a forced insertion hooking spring arm portion 65C which has a wide width and relatively high rigidity and the forced insertion locking end portion 66. The hooking spring arm portion 65C is connected to one edge portion 61eC of the plate-like main body portion 61a in the rear anchor portion 65aC, and includes a rear anchor side arm portion 65bC which extends from the rear anchor portion 65aC and a forward end side arm portion 65dC which is bent approximately perpendicular to a forward end 65cC of the rear anchor side arm portion 65bC and extends. The forced insertion locking end portion 66 includes the locking protrusion 66a which horizontally extends from the forward end of a forward end side arm portion 65dC. In the lower edge side of the locking protrusion 66a, the inclined guide surface 66b is formed as a forced insertion guide inclination surface. In the upper side, the locking surface 66c which approximately horizontally extends is formed as a forced insertion locking surface. The above points are the same as in the case of the forced insertion locking end portion 66 of the forced insertion hooking spring portion 62 of the ratchet sliding wheel spring structure 1. The return spring portion 64B has the same shape and location as those of the return spring portion 64B of the ratchet sliding wheel spring structure 1B shown in FIG. 9 in practice.

In the ratchet sliding wheel spring structure 1C, the rigidity of the forced insertion hooking spring portion 62C (forced insertion hooking spring arm portion 65C thereof) is relatively high. Therefore, even when the positioning spring portion 63 is not provided independently, the plate-like placement portion 61C defining a reference position of the ratchet sliding wheel spring structure 1C is maintained at a predetermined position of the first wheel bridge 10 at a desired posture by the fitting between an opening 61bC of the plate-like placement portion 61C and the protrusion 15a of the concave portion 13 of the first wheel bridge 10 and by the engagement or locking between the positioning locking protrusion 66 and the back surface 13d (See FIGS. 2A to 2D) of the plate-like portion 13b of the edge of the opening 16 of the first wheel bridge 10.

In the ratchet sliding wheel spring structure 1C, since the plate-like placement portion 61C and the forced insertion hooking spring portion 62C are provided, the mounting on the first wheel bridge 10 can be easily and reliably performed and the concern that the ratchet sliding wheel structure 1C may be removed from the first wheel bridge 10 can be suppressed relatively low.

In addition, since the positioning spring portion 62B is cut out in the ratchet sliding wheel spring portion structure 1C, the locking operation due to the forced insertion hooking spring portion 62C may vary depending on the rocking positions of the return spring portion 64B in the H1 and H2 directions and the rocking effect of the return spring portion 64B in the U1 direction may be easily received. In addition, in the ratchet sliding wheel spring structure 1C, since the rigidity of the forced insertion hooking spring portion 62C is relatively high, there is concern that back lash may be caused to some extent by the manufacturing tolerance of the spring portion 62C and the tolerance of the convex and concave portions corresponding to the concave portion 13 of the first wheel bridge 10.

What is claimed is:

1. A hand-wound timepiece return spring structure comprising:
a plate-like placement portion that is placed on a surface of a support member;
a forced insertion hooking spring portion that is forcibly inserted into an opening of a locking plate-like portion of the support member, has a forced insertion locking end portion, which is locked in a back surface of a wall defining the opening, in the locking plate-like portion, and is provided with a hooking spring arm portion extending from one edge portion of the plate-like placement portion; and
a return spring portion that extends from the other edge portion of the plate-like placement portion.

2. The hand-wound timepiece return spring structure according to claim 1, further comprising,
a positioning spring portion that includes a positioning spring arm portion extending parallel to the hooking spring arm portion from the one edge portion of the plate-like placement portion and a forced insertion engagement end portion engaged with the opening of the support member at the forward end portion.

3. The hand-wound timepiece return spring structure according to claim 1,
wherein the forced insertion locking end portion of the forced insertion hooking spring portion has a forced insertion guiding inclination surface as a forward end side and a forced insertion locking surface as a rear anchor side.

4. The hand-wound timepiece return spring structure according to claim 2,
wherein the forced insertion locking end portion of the forced insertion hooking spring portion has a forced insertion guiding inclination surface as a forward end side and a forced insertion locking surface as a rear anchor side.

5. The hand-wound timepiece return spring structure according to claim 1, wherein the other edge portion, which is connected to the return spring portion, of the plate-like placement portion is located on a side opposite to the one edge portion, which is connected to the forced insertion hooking spring portion, of the plate-like placement portion, and
the return spring portion extends in a direction intersecting with the hooking spring arm portion of the forced insertion hooking spring portion.

6. The hand-wound timepiece return spring structure according to claim 2,
wherein the other edge portion, which is connected to the return spring portion, of the plate-like placement portion is located on a side opposite to the one edge portion, which is connected to the forced insertion hooking spring portion, of the plate-like placement portion, and
the return spring portion extends in a direction intersecting with the hooking spring arm portion of the forced insertion hooking spring portion.

7. The hand-wound timepiece return spring structure according to claim 3,
wherein the other edge portion, which is connected to the return spring portion, of the plate-like placement portion is located on a side opposite to the one edge portion, which is connected to the forced insertion hooking spring portion, of the plate-like placement portion, and
the return spring portion extends in a direction intersecting with the hooking spring arm portion of the forced insertion hooking spring portion.

8. The hand-wound timepiece return spring structure according to claim 4,
wherein the other edge portion, which is connected to the return spring portion, of the plate-like placement portion is located on a side opposite to the one edge portion, which is connected to the forced insertion hooking spring portion, of the plate-like placement portion, and
the return spring portion extends in a direction intersecting with the hooking spring arm portion of the forced insertion hooking spring portion.

9. The hand-wound timepiece return spring structure according to claim 1,
wherein the other edge portion, which is connected to the return spring portion, of the plate-like placement portion is located adjacent to the one edge portion, which is connected to the forced insertion hooking spring portion, of the plate-like placement portion, and
the return spring portion extends parallel to the hooking spring arm portion of the forced insertion hooking spring portion.

10. The hand-wound timepiece return spring structure according to claim 2,
wherein the other edge portion, which is connected to the return spring portion, of the plate-like placement portion is located adjacent to the one edge portion, which is connected to the forced insertion hooking spring portion, of the plate-like placement portion, and
the return spring portion extends parallel to the hooking spring arm portion of the forced insertion hooking spring portion.

11. The hand-wound timepiece return spring structure according to claim 3,
wherein the other edge portion, which is connected to the return spring portion, of the plate-like placement portion is located adjacent to the one edge portion, which is connected to the forced insertion hooking spring portion, of the plate-like placement portion, and
the return spring portion extends parallel to the hooking spring arm portion of the forced insertion hooking spring portion.

12. The hand-wound timepiece return spring structure according to claim 4,
wherein the other edge portion, which is connected to the return spring portion, of the plate-like placement portion is located adjacent to the one edge portion, which is connected to the forced insertion hooking spring portion, of the plate-like placement portion, and
the return spring portion extends parallel to the hooking spring arm portion of the forced insertion hooking spring portion.

13. The hand-wound timepiece return spring structure according to claim 5,
wherein the other edge portion, which is connected to the return spring portion, of the plate-like placement portion is located adjacent to the one edge portion, which is connected to the forced insertion hooking spring portion, of the plate-like placement portion, and
the return spring portion extends parallel to the hooking spring arm portion of the forced insertion hooking spring portion.

14. The hand-wound timepiece return spring structure according to claim 6,
wherein the other edge portion, which is connected to the return spring portion, of the plate-like placement portion is located adjacent to the one edge portion, which is connected to the forced insertion hooking spring portion, of the plate-like placement portion, and
the return spring portion extends parallel to the hooking spring arm portion of the forced insertion hooking spring portion.

15. The hand-wound timepiece return spring structure according to claim 7,
wherein the other edge portion, which is connected to the return spring portion, of the plate-like placement portion is located adjacent to the one edge portion, which is connected to the forced insertion hooking spring portion, of the plate-like placement portion, and
the return spring portion extends parallel to the hooking spring arm portion of the forced insertion hooking spring portion.

16. The hand-wound timepiece return spring structure according to claim 8,
wherein the other edge portion, which is connected to the return spring portion, of the plate-like placement portion is located adjacent to the one edge portion, which is connected to the forced insertion hooking spring portion, of the plate-like placement portion, and
the return spring portion extends parallel to the hooking spring arm portion of the forced insertion hooking spring portion.

17. The hand-wound timepiece return spring structure according to claim 1,
wherein the plate-like placement portion has an opening which is engaged with a convex portion protruding from the surface of the support member.

18. The hand-wound timepiece return spring structure according to claim 2,
wherein the plate-like placement portion has an opening which is engaged with a convex portion protruding from the surface of the support member.

19. A hand-wound mechanism,
wherein the hand-wound timepiece return spring structure according to claim 1 applies an elastic force, which displaces a ratchet sliding wheel from a non-meshing position of releasing the meshing with a second transmitting wheel to a meshing position of meshing with the second transmitting wheel, to the ratchet sliding wheel.

20. A hand-wound timepiece comprising the hand-wound return spring structure according to claim 1.
